(19) United States
(12) Patent Application Publication
(10) Pub. No.: US 2006/0051160 A1
(43) Pub. Date: Mar. 9, 2006

(54) Ball joint assembly for gas spring

(75) Inventors: Cheolgon Sun, Gimhae-si (KR); Joon Jae Lee, Yangsan-si (KR); Dong Woog Oh, Gimhae-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: SUN PREIN CO., LTD., Gimhae-si (KR)

(21) Appl. No.: 11/023,656

(22) Filed: Dec. 28, 2004

(30) Foreign Application Priority Data
Sep. 7, 2004 (KR) 2004-0071418

(51) Int. Cl. F16D 1/12

(52) U.S. Cl. 403/122

(57) ABSTRACT

Disclosed is a ball joint assembly for a gas spring. The ball joint assembly includes a ball joint provided at both ends of the gas spring. The ball joint is formed at an inner portion thereof with a ball insertion hole, into which upper and lower backup rings are sequentially accommodated so as to prevent a support ball of a ball stud from being spaced from an inner wall of the ball insertion hole when the support ball of the ball stud is inserted into the ball insertion hole. An inner nut is coupled into a lower portion of the ball insertion hole or a washer is inserted into the lower portion of the ball insertion hole through a caulking process so as to prevent the upper and lower backup rings from being separated from the ball insertion hole. The ball insertion hole of the ball joint includes an opening section, which is positioned opposite to the ball receiving section. A coupling recess is formed at an upper end of the support ball of the ball stud in order to improve assembling efficiency for the ball stud.

### CROSS REFERENCE TO RELATED APPLICATIONS

This application claims the priority of Korean Patent Application No. 10-2004-0071418, filed on Sep. 7, 2004, in the Korean Intellectual Property Office, the disclosure of which is incorporated herein in its entirety by reference.

### BACKGROUND OF THE INVENTION

1. Field of the Invention

The present invention relates to a ball joint for a gas spring, and more particularly to a ball joint assembly for a gas spring used in seats of vehicles, airplanes or trucks, capable of preventing a ball stud coupled to a ball joint from being spaced from the ball joint while improving assembling work for the ball joint assembly.

2. Description of the Prior Art

As generally known in the art, seats of vehicles, airplanes or trucks are provided therein with gas springs. Such a gas spring includes a cylinder filled with gas or oil and a piston rod inserted into the cylinder.

As shown in FIGS. 1 and 2, a conventional gas spring 1 is provided at both ends thereof with a ball joint 2. When a support ball 5 provided at one end of a ball stud 6 having a bolt section 3 and a nut section 4 is inserted into a ball insertion hole 2a of the ball joint 2, a C-ring 7 is provided at a lower portion of the ball insertion hole 2a in order to prevent the support ball 5 of the ball stud 6 from being separated from the ball insertion hole 2a.

However, since the ball joint 2 for the conventional gas spring 1 is fabricated through a hot-rolling process or an injection molding process, it is difficult to freely adjust an interval of the support ball 5 of the ball stud 6 with respect to the ball insertion hole 2a of the ball joint 2 formed at both ends of the gas spring 1. If a large interval is formed between the support ball 5 of the ball stud 6 and the ball insertion hole 2a of the ball joint 2, loud noise may be generated when the gas spring 1 operates.

In addition, when installing the gas spring 1, the nut section 4 provided at a lower portion of the ball stud 6 is fastened by means of a coupling tool in a state that the ball stud 6 has been coupled with the ball joint 2 of the gas spring 1, so assembling work for the ball stud 6 with respect to the gas spring 1 must be performed in a limited space, deteriorating assembling efficiency for the ball stud 6.

### SUMMARY OF THE INVENTION

Accordingly, the present invention has been made to solve the above-mentioned problems occurring in the prior art, and an embodiment of the present invention provides a ball joint assembly for a gas spring capable of preventing a support ball of a ball stud from being spaced from a ball insertion hole of a ball joint. The embodiment also provides a ball joint assembly for a gas spring that allows workers to easily and simply perform coupling work for a ball stud with respect to the ball joint assembly when installing the gas spring.

According to various embodiments of the invention, a ball joint assembly for a gas spring comprises: a ball joint provided at both ends of the gas spring and formed at an inner portion thereof with a ball insertion hole; a ball stud having a support ball inserted into the ball insertion hole of the ball joint; a gap prevention member interposed between the ball insertion hole of the ball joint and the support ball of the ball stud so as to prevent the support ball from being spaced from an inner wall of the ball insertion hole; and a fixing member installed at an inner portion of a ball receiving section of the ball insertion hole so as to prevent the gap prevention member from being separated from the ball insertion hole.

According to an embodiment of the present invention, the gap prevention member includes an upper backup ring and a lower backup ring.

According to an embodiment of the present invention, the fixing member includes an inner nut coupled into an inner portion of the ball receiving section of the ball insertion hole.

According to an embodiment of the present invention, the fixing member includes a washer inserted into the ball receiving section of the ball insertion hole through a caulking process.

According to an embodiment of the present invention, the ball insertion hole of the ball joint includes an opening section which is positioned opposite to the ball receiving section so as to expose the support ball of the ball stud to an exterior, and a coupling recess is formed on an upper end of the support ball of the ball stud so as to allow workers to couple the ball stud with other structures by handling the coupling recess.

According to an embodiment of the present invention, the support ball of the ball stud is formed at an upper portion thereof with a cutting surface and the coupling recess is formed at a center of the cutting surface.

According to various embodiments of the invention having the above structure, the support ball of the ball stud can be prevented from being spaced from the inner wall of the ball insertion hole of the ball joint when the support ball of the ball stud has been inserted into the ball insertion hole, so that coupling work for the ball stud can be easily carried out.

### BRIEF DESCRIPTION OF THE DRAWINGS

The above and other features and advantages of the present invention will be more apparent from the following detailed description taken in conjunction with the accompanying drawings, in which:

FIG. 1 is a sectional view illustrating a structure of a conventional ball joint assembly for a gas spring;

FIG. 2 is an exploded perspective view of a conventional ball joint assembly shown in FIG. 1;

FIG. 3 is a front view of a gas spring according to one embodiment of the present invention;

FIG. 4 is a sectional view illustrating a structure of a ball joint assembly for a gas spring according to one embodiment of the present invention;

FIG. 5 is an exploded perspective view of a ball joint assembly shown in FIG. 4; and

FIG. 6 is a sectional view illustrating a structure of a ball joint assembly for a gas spring according to another embodiment of the present invention.

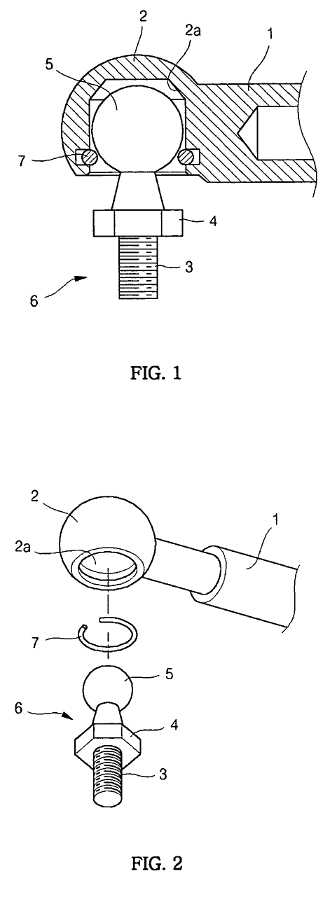

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

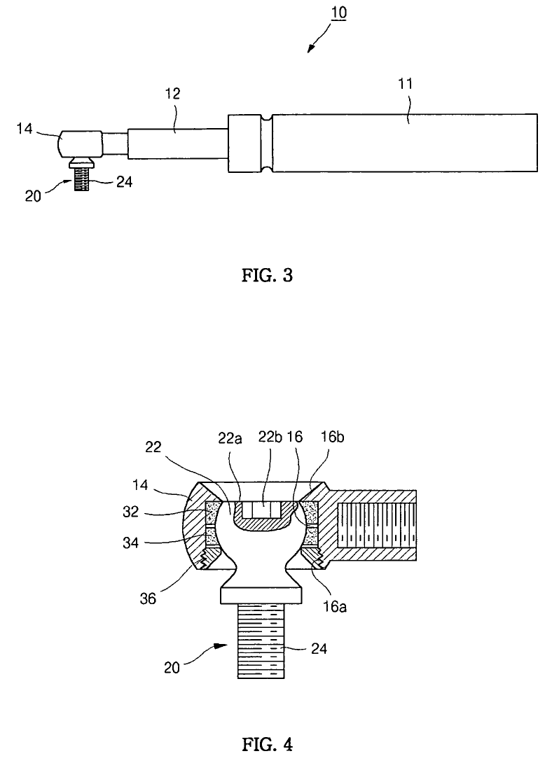

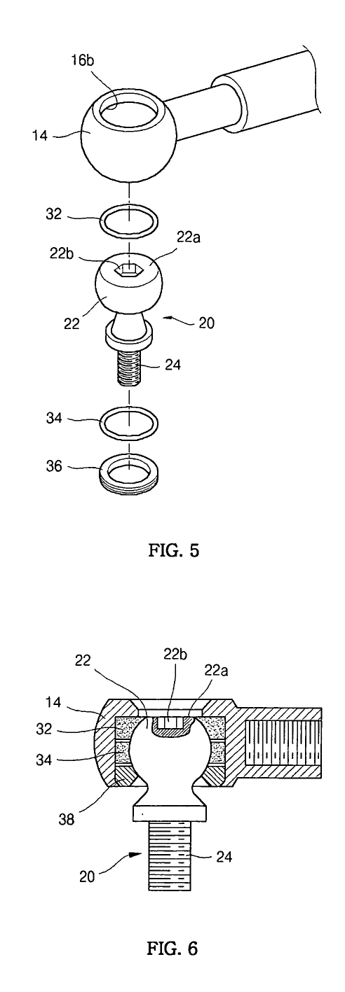

FIG. 3 is a front view of a gas spring according to one embodiment of the present invention, FIG. 4 is a sectional view illustrating a structure of the ball joint assembly for the gas spring according to one embodiment of the present invention, and FIG. 5 is an exploded perspective view of the ball joint assembly shown in FIG. 4.

The gas spring 10 according to one embodiment of the present invention includes a cylinder 11 and a piston rod 12 inserted into the cylinder 11 and protruding from the cylinder 11. A ball joint 14 coupled with a ball stud 20 is provided at both sides of the gas spring 10.

The ball stud 20 includes a support ball 22 and a bolt section 24 extending from a lower portion of the support ball 22.

The ball joint 14 is provided at an inner portion thereof with a ball insertion hole 16. A ball receiving section 16a is formed at one side of the ball insertion hole 16 so as to receive the support ball 22 of the ball stud 20, and an opening section 16b is formed at the other side of the ball insertion hole 16 for allowing a worker to fix the ball stud 20 in the ball insertion hole 16 through the opening section 16b.

In addition, upper and lower backup rings 32 and 34 are accommodated in the ball insertion hole 16 so as to prevent the support ball 22 of the ball stud 20 from being spaced from an inner wall of the ball insertion hole 16 when the support ball 22 of the ball stud 20 has been inserted into the ball insertion hole 16. An inner nut 36 is provided below the lower backup ring 34 so as to prevent the upper and lower backup rings 32 and 34 from being separated from the ball insertion hole 16.

The support ball 22 of the ball stud 20 is formed at an upper portion thereof with a cutting surface 22a. In addition, the cutting surface 22a is formed at a center thereof with a coupling recess 22b for allowing a worker to screw-couple the bolt section 24 of the ball stud 20 into other structures by handling the coupling recess 22b using a coupling tool.

Hereinafter, an operation of the ball joint assembly having the above structure according to one embodiment of the present invention will be described.

First, the upper backup ring 32 is inserted into the ball insertion hole 16 of the ball joint 14 formed at both ends of the gas spring 10 before the support ball 22 of the ball stud 20 is inserted into the ball insertion hole 16 of the ball joint 14.

Then, the lower backup ring 34 and the inner nut 36 are sequentially disposed around the support ball 22 of the ball stud 20. In this state, the support ball 22 of the ball stud 20 is inserted into the ball insertion hole 16 of the ball joint 14 through the ball receiving section 16a.

After the support ball 22 of the ball stud 20 has been inserted into the ball insertion hole 16 of the ball joint 14, the inner nut 36 is screw-coupled into a lower portion of the ball insertion hole 16 of the ball joint 14. Thus, the support ball 22 of the ball stud 20 closely makes contact with inner walls of the upper and lower backup rings 32 and 34 inserted into the ball insertion hole 16. Accordingly, the support ball 22 of the ball stud 20 can be stably inserted into the ball insertion hole 16 of the ball joint 14 without forming a space between the support ball 22 and the inner walls of the upper and lower backup rings 32 and 34.

When installing the gas spring 10 in a state that the ball stud 20 has been coupled with the ball joint 14, the worker rotates the coupling recess 22b of the cutting surface 22a formed at the upper portion of the support ball 22 of the ball stud 20 by inserting the coupling tool into the coupling recess 22b through the opening section 16b formed at the other end of the ball joint 14. That is, the worker rotates the ball stud 20 from an upper portion of the ball stud 20 by means of the coupling tool, so that the gas spring 1 can be simply installed.

According to another embodiment of the present invention, as shown in FIG. 6, a washer 38 is inserted into the lower portion of the ball insertion hole 16 of the ball joint 14 for the gas spring through a caulking process, instead of the inner nut 36, so that the upper and lower backup rings 32 and 34 are fixedly maintained in the ball insertion hole 16 without being separated from the ball insertion hole 16.

The ball joint assembly according to another embodiment of the present invention has an advantage in that the support ball 22 of the ball stud 20 can be semi-permanently positioned within the ball insertion hole 16 of the ball joint 14 without being separated from the ball insertion hole 16.

As described above, the ball joint assembly for the gas spring according to the present invention can prevent the support ball of the ball stud from being spaced from the inner wall of the ball insertion hole of the ball joint when the support ball of the ball stud has been inserted into the ball insertion hole, so the gas spring stably operates without generating noise even if an axis of the ball joint does not match with an axis of the ball stud.

In addition, an interval between the support ball and the ball insertion hole of the ball joint can be adjusted according to uses of the ball joint assembly, if necessary.

Furthermore, according to the present invention, coupling work for the ball stud of the gas spring can be easily performed by handling the ball stud from the upper portion of the ball stud by means of the coupling tool, so assembling work for the ball stud can be improved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A ball joint assembly for a gas spring, the ball joint assembly comprising:
a ball joint comprising an inner wall that defines cavity having an opening at its bottom;
a ball stud comprising a support ball, the ball stud being coupled to the ball joint such that at least a portion of the support ball is disposed within the cavity and at least a portion of the ball stud extends through the opening at the bottom of the cavity;
a gap prevention member interposed between the inner wall and the support ball to inhibit movement of the support ball relative to the inner wall; and
a fixing member secured to the inner wall proximate to the opening at the bottom pf the cavity, thereby preventing the gap prevention member from leaving the cavity.

2. The ball joint assembly as claimed in claim 1, wherein the gap prevention member comprises an upper backup ring and a lower backup ring.

3. The ball joint assembly as claimed in claim 1, wherein the fixing member comprises an inner nut threadingly engaged to the inner wall.

4. The ball joint assembly as claimed in claim 1, wherein the fixing member comprises a washer coupled to the inner wall through a caulking process.

5. The ball joint assembly as claimed in claim 1,
wherein the support ball has a substantially planar, upper surface,
wherein a coupling recess is defined within the upper surface of the support ball, and
wherein the coupling recess is aligned with the opening at the top of the cavity so as to allow a worker to couple a tool to the coupling recess via the opening at the top of the cavity.

6. The ball joint assembly as claimed in claim 5, wherein the coupling recess is formed proximate to the center of the upper surface.

7. A ball joint assembly for a gas spring, the ball joint assembly comprising:
a ball joint comprising a substantially cylindrical inner wall, wherein the inner wall defines a cavity having a top opening and a bottom opening;
a ball stud comprising a support ball and a bolt section,
the support ball comprising an upper portion and a lower portion, the upper portion comprising a substantially spherical lateral surface, the upper portion being disposed within the cavity and abutting the top opening, at least a portion of the lower portion extending out of the cavity through the bottom opening,
wherein the lateral surface is disposed at an interval from the inner wall,
and wherein the bolt section extends from the lower portion; and
a spacing member disposed between and engaging the lateral surface and the inner wall so as to prevent changes in the interval.

8. The ball joint assembly of claim 7,
wherein the inner wall comprises a threaded portion proximate to the bottom opening, the assembly further comprising a nut threadingly engaged to the threaded portion, the nut having a center opening whose diameter is less than the maximum diameter of the substantially spherical lateral surface of the support ball, and
wherein the support ball is disposed between the nut and the top opening.

9. The ball joint assembly of claim 7, further comprising
a washer secured to the inner wall proximate to the bottom opening by caulk, the washer having a center opening whose diameter is less than the maximum diameter of the substantially spherical lateral surface of the support ball, and
wherein the support ball is disposed between the washer and the top opening.

10. The ball joint assembly of dam 7, wherein the upper portion of the support ball further comprises a substantially planar upper surface having a recess defined therein, the recess being configured to be engaged by a tool for manipulating the gas spring.

11. The ball joint of claim 10, wherein the tool is a tool for rotating the ball stud to install the gas spring.

12. The ball joint assembly of claim 10, wherein the recess is positioned so that it is accessible via the top opening.

13. The ball joint assembly of claim 7, wherein the spacing member is a ring that is disposed around and in contact with a portion of the substantially spherical lateral surface.

14. The ball joint assembly of claim 7, wherein the spacing member is a first ring disposed around and in contact with a portion of the substantially spherical lateral surface, the assembly further comprising a second ring disposed around and in contact with a portion of the substantially spherical lateral surface, the second ring being disposed below the first ring.

15. A gas spring comprising:
a cylinder,
a piston rod inserted into the cylinder,
a joint coupled to the piston rod, the joint comprising an inner wall that defines cavity having an opening at its bottom;
a stud comprising a support means, the stud being coupled to the joint such that at least a portion of the support means is disposed within the cavity and at least a portion of the stud extends through the opening at the bottom of the cavity;
a gap prevention means interposed between the inner wall and the support means to inhibit movement of the support means relative to the inner wall; and
a fixing means secured to the inner wall proximate to the opening at the bottom of the cavity, thereby preventing the gap prevention means from leaving the cavity.

16. The gas spring of claim 15, wherein the support means is a support ball having a substantially spherical lateral surface, the gap prevention means being disposed around the lateral surface and in substantial contact with both the lateral surface and the inner wall.

17. The gas spring of claim 15, wherein the gap prevention means is a ring that is disposed around the support means and in substantial contact with both the support means and the inner wall.

18. The gas spring of claim 15, wherein the fixing means is a nut that is engaged to the inner wall so as to hold the support means in place.

19. The gas spring of claim 15, wherein the fixing means is a washer that is engaged to the inner wall so as to hold the support means in place.

20. The gas spring of claim 15, wherein the joint is a first joint at one side of the gas spring, the gas spring further comprising a second joint at another side of the gas spring.
